(19) United States
(12) Patent Application Publication
(10) Pub. No.: US 2016/0144915 A1
(43) Pub. Date: May 26, 2016

(54) INTERACTIVE CYCLIST MONITORING AND ACCIDENT PREVENTION SYSTEM

(71) Applicant: NORTHEASTERN UNIVERSITY, Boston, MA (US)

(72) Inventors: Amir Bahador Farjadian Bejestan, Brookline, MA (US); Qingchao Kong, Boston, MA (US); Carlo Sartori Pacifici, Boston, MA (US); Philip Damian Lena, Bolton, MA (US); Alexander Pepjonovich, Quincy, MA (US); Camilo Madriz, Boston, MA (US); Marietta Alcover Ramos, Boston, MA (US); Constantinos Mavroidis, Arlington, MA (US)

(21) Appl. No.: 14/898,551

(22) PCT Filed: Feb. 6, 2014
(86) PCT No.: PCT/US2014/015102

§ 371 Date: Dec. 15, 2015

Related U.S. Application Data
(60) Provisional application No. 61/910,502, filed on Dec. 2, 2013.
(60) Provisional application No. 61/835,790, filed on Jun. 17, 2013.

(51) Int. Cl. B62J 6/00

(52) U.S. Cl. CPC B62J 6/00; B62J 2700/636

(57) ABSTRACT

The present application is directed towards methods and systems for an interactive cyclist monitoring and crash prevention system. The methods include creating, by a safety sensor, a virtual smart lane around a bike operated by a rider during a cycling session. The virtual smart lane may indicates a safe zone around the bike. The method further includes the safety sensor detecting an object approaching the virtual smart lane during the cycling session and generating an alert to the rider of the bike to notify the rider of the approaching object.

### RELATED APPLICATIONS

This patent application claims the benefit of U.S. Provisional Patent Application No. 61/835,790, filed on Jun. 17, 2013, titled “Cyclist Monitoring, Recommender, and Crash Prevention System,” as well as U.S. Provisional Patent Application No. 61/910,502, filed on Dec. 2, 2013, titled “Interactive Cyclist Monitoring and Accident Prevention System,” the disclosures of which are incorporated herein by reference in their entirety.

### BACKGROUND

The number of bicycle trips has more than doubled in the past decade, and major cities in the U.S. have experienced more than 80% increase in the number of cyclist commuters. This rapidly growing bike culture is supported by the economical, health and environmental causes. However, this rapid growth is accompanied by a steady growth in the rate of bicycle accidents and fatalities. In 2011 alone, there were 1.85 pedal-cyclists deaths and more than 130 reported injuries per day in the United States. The great majority of bike accidents occurred as a result of crashes with motor vehicles. Further, most of the bike accidents were due to human factors attributed to the cyclists. The lack of safety is a major contributing factor to lower the use of bicycles on the streets and which prevents us from aforementioned benefits.

### SUMMARY

The present application is directed towards a modular accessory for a bicycle so as to make the cycling exercise safer on the streets. The proposed system is composed of three parts: a front console, a back console and a computer-based application. In some embodiments, the front and back consoles can be removable attachments that will be installed on the steering wheel and seat post, respectively. In an embodiment, the front and back consoles can be integrated with line-lasers, proximity sensors, vibrators, LEDs and speakers. In some embodiment, each console may include two line-lasers to project a virtual bike lane on the ground. Additionally, in an embodiment, a pair of proximity sensors can be integrated into each console to detect objects around the cyclist. In some embodiments, the speaker can alert the cyclist in case of any dangerous situation. Additionally, in an embodiment, by using a series of LEDs, the back console can provide the signaling and the front console can illuminate the road ahead.

In one aspect, the present disclosure is related to a method for interactive cyclist monitoring and crash prevention. The method includes creating, by a safety sensor, a smart lane around a bike operated by a rider during a cycling session. The smart lane may indicate a safe zone around the bike. The method further includes detecting, by the safety sensor, an object approaching the smart lane during the cycling session; and generating, by the safety sensor, an alert to the rider of the bike to notify the rider of the approaching object. In some embodiments, the method includes the safety sensor generating the smart lane on a surface around the bike during the cycling session. In other embodiments, the smart lane may be displayed on a computing device display visible by the rider during the cycling session.

In some embodiments, the method includes determining, by the safety sensor, the object has come within a pre-determined distance of the bike. In an embodiment, the safety sensor may detect a change in a cycling route condition. In one embodiment, the safety sensor may detect a detect a change in a road condition. The change in the road condition may include at least one of a pothole and a change in elevation of the road. In some embodiments, the safety sensor may generate an alert. In an embodiment, the safety sensor may transmit to a processor commands to activate at least one of a speaker, a laser light, and a vibrator. The alert can include at least one of an audio alert, visual alert, and a tactile alert. In some embodiments, the audio alert may include generating, by a speaker, audio commands to the rider to change a current bike characteristic of the cycling session. In an embodiment, the visual alert may include changing, by a laser light, a light behavior corresponding the smart lane to change a visual view of the smart lane. In some embodiments, the method further includes blinking, by a laser light, lanes of the virtual smart lane to notify the rider when a motor vehicle approaches the virtual smart lane.

In an embodiment, the method further includes changing a display of the virtual smart lane on a hand held computing device to notify the rider when a motor vehicle approaches the virtual smart lane. In some embodiments, the tactile alert includes vibrating, by a vibrator, a component of the bike structure to alert the rider of the approaching object. In an embodiment, the tactile alert further includes vibrating a component of the bike structure to alert the rider of a dangerous situation. The dangerous situation may include at least one of an upcoming intersection in the road and a sharp turn in the road. In an embodiment, the safety sensor can be coupled to at least one of a motorcycle and a motor vehicle. In some embodiments, the method includes receiving, by the safety sensor, input from a user via a user interface.

In another aspect, the present disclosure is related to a system for interactive cyclist monitoring and crash prevention. The system may include a safety sensor. The safety sensor may be configured to create a smart lane around a bike operated by a rider during a cycling session. The smart lane may indicate a safe zone around the bike. The safety sensor may be further configured to detect an object approaching the smart lane during the cycling session and generate an alert to the rider of the bike to notify the rider of the approaching object. In some embodiments, the smart lane may be generated on a surface around the bike during the cycling session In an embodiment, the smart lane can be displayed on a computing device display visible by the rider during the cycling session.

In some embodiments, the safety sensor may be configured to determine the object has come within a pre-determined distance of the bike. In an embodiment, the safety sensor may be further configured to detect a change in a cycling route condition. In some embodiments, the safety sensor may be configured to detect a change in a road condition. The change in the road condition may include at least one of a pothole and a change in elevation of the road. In some embodiments, the safety sensor can be configured to generate an alert. In an embodiment, the safety sensor can be configured to transmit to a processor commands to activate at least one of a speaker, a laser light, and a vibrator. The alert may include at least one of an audio alert, visual alert, and a tactile alert. In some embodiments, the audio alert can include a generated command to the rider to change a current bike characteristic of the cycling session.

In an embodiment, the visual alert can include a change in a light behavior corresponding the smart lane to change a visual view of the smart lane. In some embodiments, the tactile alert can include vibrating a component of the bike structure to alert the rider of the approaching object. In an embodiment, the tactile alert can include vibrating a component of the bike structure to alert the rider of a dangerous situation. The dangerous situation may include at least one of an upcoming intersection in the road and a sharp turn in the road. In an embodiment, the safety sensor can be coupled to at least one of a motorcycle and a motor vehicle. In some embodiments, the safety sensor can be configured to receive input from a user via a user interface. In an embodiment, a laser light can be configured to blink lanes of the virtual smart lane to notify the rider when a motor vehicle approaches the virtual smart lane. In some embodiments, the safety sensor can be configured to change a display of the virtual smart lane on a hand held computing device to notify the rider when a motor vehicle approaches the virtual smart lane.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are; therefore, not to be considered limiting of its scope, the disclosure will be described with additional specificity and detail through use of the accompanying drawings.

FIG. 1 depicts an illustration of an embodiment of a virtual coach system.

FIG. 2 depicts an illustration of an embodiment of an expanded view of a pedal mechanism.

FIG. 3A depicts a side view of an embodiment of a pedal sensor.

FIG. 3B depicts a perspective view of the pedal sensor of FIG. 3A.

FIG. 4A depicts an illustration of angular relationship to a crank shaft to a pedal.

FIG. 4B depicts an illustration of a relationship of a flywheel to a rear wheel.

FIG. 5 depicts an illustration of the steps taken in one embodiment of a method for monitoring and providing recommendations to a rider during a cycling session.

FIG. 6A is a block diagram illustrating a general architecture for a computer system that may be employed to implement various elements of the systems and methods described herein, in accordance with an embodiment.

FIG. 6B is a block diagram illustrating an embodiment of a virtual coach system.

FIG. 7 depicts an illustration of an embodiment of output of a virtual coach.

FIG. 8A depicts an illustration of an embodiment of a cutaway view of a front console for a safety sensor.

FIG. 8B depicts an illustration of an embodiment of a back console for a safety sensor.

FIG. 9A depicts an illustration of an embodiment of a visual alert system.

FIG. 9B depicts an illustration of the steps taken in one embodiment of a method for monitoring and crash prevention for a rider during a cycling session.

FIG. 10 depicts an illustration of an embodiment of a safety sensor system coupled to a bike.

FIG. 11 depicts an illustration of an embodiment of a safety sensor system.

FIG. 12 depicts an illustration of one embodiment of a visual alert.

FIG. 13A depicts an illustration of an embodiment of a range of detection.

FIG. 13B depicts an illustration of an embodiment of a laser range of detection.

FIG. 14 depicts an illustration of an embodiment of an unstable rider detection.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

A concept and design of an electronic add-on to the bike structure is described herein. The add-on is composed of a smart pedal in conjunction with a computer-based application, i.e. the recommender system or coach. The system is capable of recommending appropriate cycling strategies to improve the biking experience, based on the measured cycling characteristics in the outdoor or indoor environment. The virtual coaching system can grow and adapt with a rider the more the rider uses the system by combining and analyzing data from multiple sessions. The add-on can be augmented by other physiological transducers to provide exercise outcomes as the analogous to stationary bike in the gym.

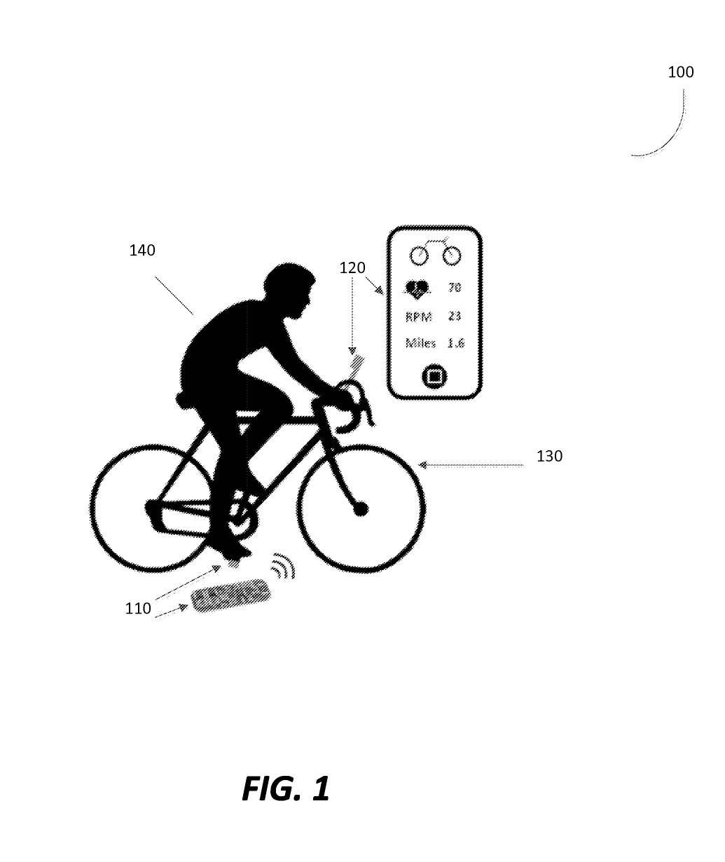

FIG. 1 depicts an illustration of an embodiment of a virtual coach system 100. The virtual coach system 100 includes a pedal sensor 110 and a virtual coach 120. In some embodiments, the pedal sensor 110 is communicatively coupled to the virtual coach 120. The pedal sensor 110 and the virtual coach 120 may be connected via wired or wireless links. The wired links may include coaxial cable lines or optical fiber lines. The wireless links may include BLUETOOTH or Wi-Fi. In some embodiments, the wireless links may include any cellular network standards sued to communicate among mobile devices, including standards that qualify as 1G, 2G, 3G, or 4G.

In an embodiment, the pedal sensor 110 can communicate with the virtual coach 120 to transmit characteristics of a bike via a wireless connection. The virtual coach 120 can display the received information and characteristics of the bike. In some embodiments, the virtual coach 120 can be an application executing on a hand-held computing device. In one embodiment, the virtual coach 120 can execute on a smart phone based application such as an IPHONE device manufactured by Apple Inc. In other embodiments, the virtual coach 120 can execute on a wearable computing device such as Google Glass device manufactured by Google, Inc. In some embodiments, the virtual coach 120 can be coupled to a bike frame. In one embodiment, the virtual coach 120 can be coupled to the handlebars of a bike so a rider can view the display during a cycling session. In an embodiment, the virtual coach 120 can transmit the characteristics of the bike to a separate computing device to review and analyze the information after the cycling session is over.

In some embodiments, the pedal sensor 110 is coupled to a pedal of a bike 130 being operated by a rider 140. As the rider 140 applies force to the pedal, the pedal has a rotation movement that can be measured to determine certain characteristics of the bike 130, for example, bike speed. In some embodiments, the pedal sensor 110 includes various instruments to measure the characteristics of the bike 130 during a cycling session. The pedal sensor 110 can then transmit these characteristics to the virtual coach 120. As illustrated in FIG. 1, the characteristics can be displayed to the rider 140. Further, the virtual coach can manipulate the characteristics to generate recommendations to the rider to increase the riding experience.

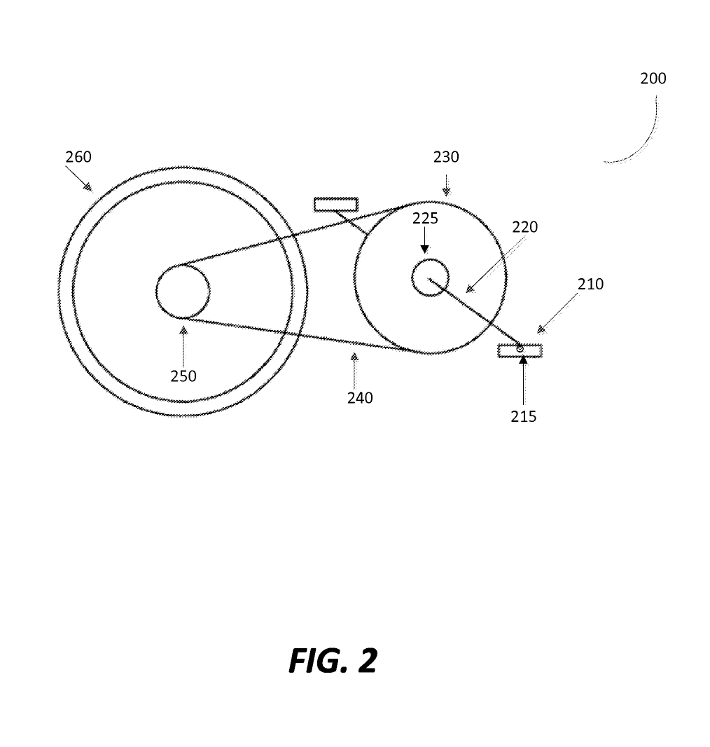

As stated above, the pedal sensor is detecting characteristics of the bike 130 based on the operation of the pedal. FIG. 2 depicts an illustration of an embodiment of an expanded view of a pedal mechanism 200. In some embodiments, the pedal mechanism includes a pedal 210, a crank shaft 220, and a chainring 230. In an embodiment, the pedal mechanism 200 may be coupled to a rear wheel 260 of a bicycle via a chain 240 and a cassette 250. As the rider applies force on the pedal, the pedal will have a movement of translation around the crank's pivot 225 and rotation around its own pivot 215. Its own pivot 215 may be any type of mechanical adapter to connect the peal to the crank shaft. The crank shaft's pivot 225 may be a connection point connecting the crank shaft to the chainring.

In some embodiments, the pedal 210 is the part of a bicycle that the rider applies force to with their foot to propel the bicycle. The pedal 210 may include a pedal shaft adapter that connects to an end of the crank shaft 220. Additionally, the pedal 210 may have a body, on which the foot rests or is attached, that is free to rotate on bearings with respect to the pedal shaft. In an embodiment, the pedal shaft may be referred to as a spindle. In some embodiments, the pedal body may include a flat surface to rest the foot on. In other embodiments, the pedal body may include a cleat connection. The cleated connection, for example, may mate with a similar cleat connection point on the rider's shoes, allowing the rider to “clip into” the bike. In an embodiment, the pedal 210 provides a connection between the cyclist's foot or shoe and the crank shaft 220, allowing the leg to propel the bicycle's wheels.

In some embodiments, the crank shaft 220 is the component of a bicycle drivetrain that converts the reciprocating motion of a rider's legs into rotational motion used to drive the chainring 230 and the chain 240, which in turn drives the rear wheel 260. In some embodiments, the crank shaft 220 transfers the force applied to the pedal 210 by the rider to the chainring 230 and the chain 240. The crank shaft 220 is coupled to the pedal 210 via the pedal shaft adapter. In some embodiments, the crank shaft 220 is coupled to the chainring 230 via a bolted connection. As the rider applies force to the pedal 210, the crank shaft 220 rotates around its connection to the chainring 230. In an embodiment, the pivot 225 for the crank shaft can be where it connects to the chainrung 230. In some embodiments, this rotational movement of the crank shaft 220 causes the chainring 230 to rotate.

In some embodiments, the chainring 230 is coupled to the crank shaft 220 and the chain 240. An end of the crank shaft 210 may be connected to a middle portion of the chainring 230. In some embodiments, the crank shaft 210 may be bolted to the chainring 230. The chainring 230 may include a threaded hole through the middle of the chainring 230 to insert a bolt and connect the crank shaft 220. As the crank shaft rotates in response to force applied by the rider, the chainring 230 may rotate causing the chain 240 move. In some embodiments, the chainring 230 may have a threaded outer surface, for example, the outer circumference of the chainring 230 may shaped as teeth. The teeth of the chainring 230 may be spaced at a particular distance to engage every link of the chain 240 as it passes over. In an embodiment, as the chainring 230 rotates, the teeth grip and pull the chain 240, causing the chain 240 to rotate.

In some embodiments, the chain 240 may include links that fit into the teeth of the chainring 230. The chain 240 may be coupled to the chainring 230 and the cassette 250 on the rear wheel 260. In some embodiments, as the chain 240 is pulled by the rotational movement of the chainring 230, the chain 240 causes the cassette 250 to rotate. In some embodiments, the cassette 250 may have a threaded outer surface referred to as teeth, similar to the chainring 230. The links of the chain 240 may be coupled to the teeth of the chainring 250. The teeth of the cassette 250 may be spaced at a particular distance to engage every link of the chain 240 as it passes over. In some embodiments, the rotational movement of the cassette 250, caused by the chain 240, may cause the rear wheel 260 to rotate.

In some embodiments, the cassette 250 may be coupled to the rear wheel 260 via a mechanical adapter. In an embodiment, the cassette 250 may include a cogset. A cogset may be coupled to a rear derailleur as part of a drivetrain to provide multiple gear ratios to the rider. In some embodiments, as the cassette 250 rotates the rear wheel 260 rotates, causing the bicycle to move. In some embodiments, the cassette 250 may transfer force from the chainring 230 and chain 240 to the rear wheel 260.

In some embodiments, the rear wheel 260 can be propelled by the force a rider applies to the pedal 210. In an embodiment, the rear wheel can be coupled to the cassette 250. The rear wheel may rotate in response to forces applied on the cassette 250. Thus, measurements taken at the pedal 210 can be used to determine a speed of the rear wheel and the speed of the bike. In some embodiments, these measurements can be transmitted to a virtual coaching system to monitor and provide recommendations to a rider during a cycling session. The measurements can be taken at both pedals of a bike (i.e., left pedal and right pedal). Further, the figures and descriptions herein may make reference to only one pedal, however the various embodiments of pedal sensors described herein can be applied to both pedals on the bike.

Interactive Cyclist Monitoring and Recommendations System

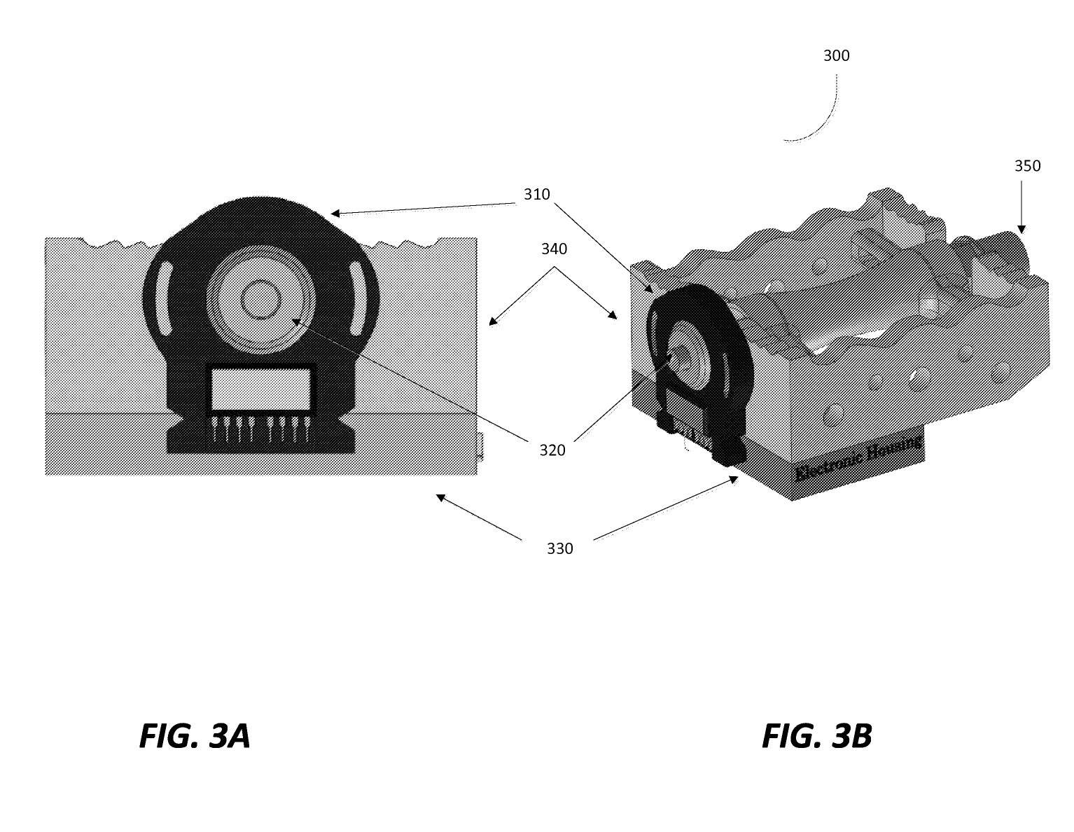

FIGS. 3A and 3B illustrate various views of a pedal sensor. FIG. 3A illustrates a side view of an embodiment of a pedal sensor 300. The pedal sensor 300 is coupled to a pedal body 340 via a pedal shaft adapter 320. The pedal sensor 300 includes a rotary sensor 310 and an electronic housing 330.

In some embodiments, the rotary sensor 310 may be connected to an end of a pedal body 340 via the pedal shaft adapter 320. In one embodiment, the rotary sensor 310 is coupled to the end of the pedal body 340, opposite of where the crank shaft is coupled to the pedal body 340 (i.e., the outer side with respect to the bike body). In some embodiments, the rotary sensor 310 may include at least one of an encoder, a continuous potentiometer, a digital counter, an accelerometer, and a gyroscope. In one embodiment, the rotary sensor 310 may include two encoders. In an embodiment, the rotary sensor 310 can measure pedaling speed as will be discussed in greater detail below. In some embodiments, the rotary sensor 310 may perform measurements continuously. In other embodiments, the rotary sensor may perform measurements once per rotation. The rotation may refer to a rotation of the pedal, crank shaft, or a wheel. In still other embodiments, the rotary sensor 310 may perform measurements at a specific time interval within a full rotation.

In some embodiments, to measure the pedaling speed, the rotary sensor may measure a pedal shaft displacement. The pedal shaft displacement may include two components, a crank shaft rotation with respect to its external reference and a pedal rotation with respect to the crank shaft, as will be discussed in greater detail below.

In some embodiments, the pedal shaft adapter 320 may couple the rotary sensor 310 to the pedal body 340. The pedal shaft adapter 320 may be any type of mechanical adapter. In one embodiment, the pedal shaft adapter 340 includes a nut and bolt to affix the rotary sensor 310 to a threaded end of the shaft of the pedal body 340.

In some embodiments, the electronic housing 330 may include the rotary sensor 310. In an embodiment, the electronic housing 330 may include micromechanical types of sensors. For example, the electronic housing 330 may include at least one of a tilt sensor, an accelerometer, a gyroscope, and an inertial measurement unit (IMU). As illustrated in FIG. 3A, the electronic housing 330 may be coupled to the pedal body 340 via a mechanical adapter. In other embodiments, the electronic housing 330 may be coupled to a crank shaft of a bike. In still other embodiments, the electronic housing 330 may be coupled to the body of the bike. In some embodiments, the electronic housing 330 and the rotary sensor 310 can be fabricated together to form one sensor. As illustrated in FIGS. 3A-3B, the electronic housing may be affixed to a bottom portion of the pedal body 340.

In some embodiments, the pedal sensor 300 may be battery powered. In an embodiment, the electronic housing 330 may include connections for a battery component. In some embodiments, the electronic housing 330 may include an electronic circuit board to power the pedal sensor 300. In an embodiment, the electronic housing 300 may include a computing device configured to collect, store, and transmit measurements from a sensor to another computing device, for example, the virtual coach.

In some embodiments, the pedal body 340 may be a standard, generic bike pedal. The pedal body 340 may include a least one flat surface for a rider to press a foot down upon. In other embodiments, the pedal body 340 may be a cleat type pedal. In such an embodiment, the rider will “clip” into the cleated connection on the pedal with a cleated connection on the rider's shoe. In still other embodiments, the pedal body 340 can be any type of bike pedal available. The rotary sensor 310 may be fabricated and/or configured to connect to any shape or type of bike pedal.

The components of the pedal sensor 300, as described herein, may comply with common electronic equipment standards. In some embodiments, the pedal sensor 300 can be fabricated to fit onto any size pedal or pedal configuration. For example, in some embodiments, the pedal sensor 300 may be fabricated to be coupled to a standard bike pedal. In other embodiments, the pedal sensor 300 may be fabricated to be coupled to a cleat type pedal. In some embodiments, all of the components of the pedal sensor 300 may be waterproof.

FIG. 3B illustrates a perspective view of the pedal sensor 300 of FIG. 3A. In more detail, FIG. 3B illustrates a cut away view of a pedal body 340 to illustrate example connection points for the pedal sensor 300 and a crank shaft. The pedal sensor 300 includes a rotary sensor 310 and an electronic housing 330. The pedal body 340 includes the a pedal shaft 350. In some embodiments, the pedal shaft 350 runs through a center portion inside of the pedal body 340. The pedal shaft 350 may be referred to as a spindle. In some embodiments, an end of the pedal shaft include a threaded end to connect the crank shaft onto, for example, via a nut and bolt. In an embodiment, the rotary sensor 310 may connect onto the end opposite of where the crank shaft connects. The rotary sensor 310 may be coupled to the pedal shaft 350 via a pedal shaft adapter 320.

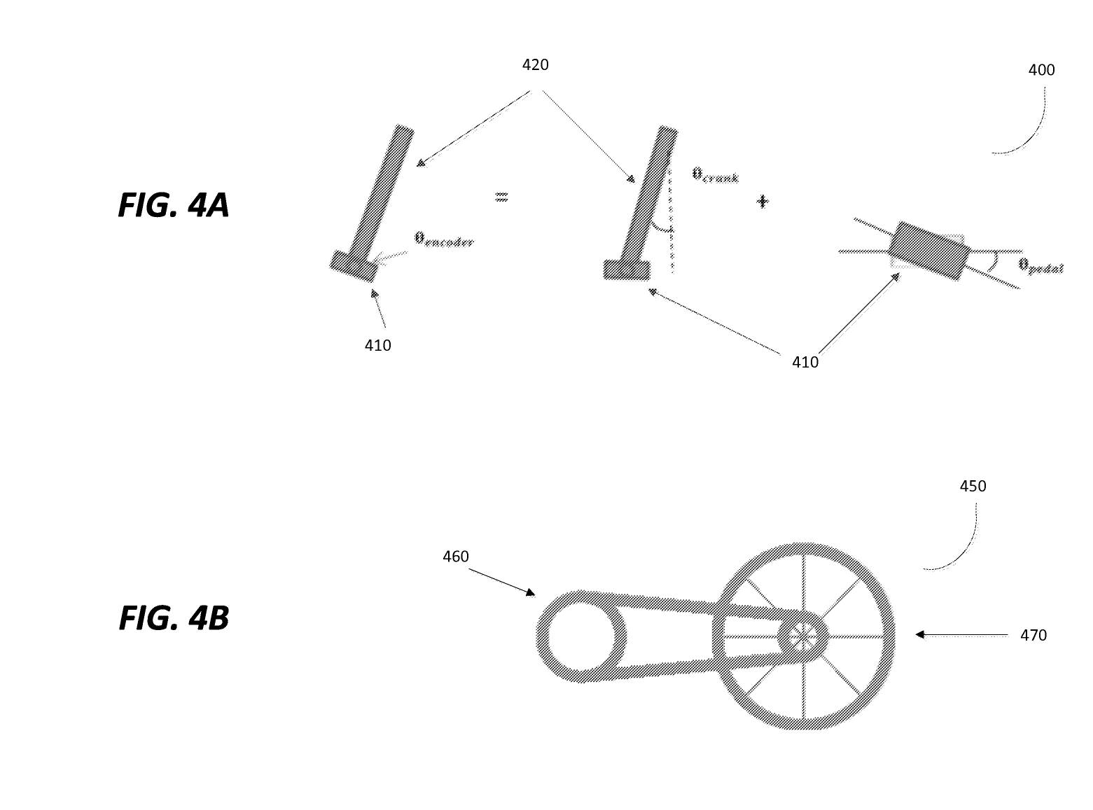

FIG. 4A depicts an illustration an embodiment of angular relationship 400 to a crank shaft to a pedal. The angular relationship 400 includes a pedal 410 and a crank shaft 420. In some embodiments, the angular relationship 400 may be referred to as a pedal shaft angular displacement. In some embodiments, while cycling, the crank shaft 420 will have a movement of rotation around its pivot while the pedal 410 will have movement of translation around the crank shaft's pivot and rotation around its pivot. By measuring the relationship between pedal 410 and the crank shaft 420, the speed of the bicycle can be determined. In some embodiments, the measurements can be performed continuously, once per rotation, or at a pre-determined time interval within a full round. In some embodiments, the pedal shaft angular displacement (Θ_{encoder}) may be composed of two components, the crank shaft rotation (Θ_{crank}) and the pedal rotation (Θ_{pedal}) with respect to the crank shaft 420. The relationship may be represented by the following equation:

Θ_{pedal}+Θ_{crank}=Θ_{encoder}

A pedal sensor, such as those described above with respect to FIGS. 1-3B, can measure the appropriate angles of the pedal 410 and the crank shaft 420. The pedal sensor can measure the angle of the pedal with respect to its reference. In an embodiment, this reference can be the pedal shaft. Further, the pedal sensor can measure the angle of the crank shaft with respect to an external reference. In an embodiment, the external reference may be the connection point to the chainring on a bike. By combining the angle measurements from the pedal 410 and the crank shaft 420, a total sensor angle can be determined.

FIG. 4B depicts an illustration of a relationship 450 of a flywheel to a rear wheel. In some embodiments, the crank shaft angle and pedal angle can be extracted from equation 1 to determine the angular velocity of a flywheel 460. In an embodiment, the chainring of a bike may be referred to as a flywheel 460. The angular velocity of the flywheel 460 can be calculated as follows:

$${ω}_{flywheel} = \frac{d {θ}_{crank}}{d t}$$

Where (ω_{flywheel}) represents the angular velocity of the flywheel 460. By determining the angular velocity of the flywheel 460, the pedal sensor or the virtual coach can use the relationship between the flywheel 460 and a rear wheel 470 of a bike to determine the bike velocity (i.e., bike speed). The relationship of the flywheel 460 to the rear wheel is illustrated in FIG. 4B. In some embodiments, based on the relationship between the flywheel 460 and rear wheel 470 of a bike, the angular velocity of the rear wheel 470 and the angular velocity of the bike can be calculated as follows:

ω_{flywheel}*r_{flywheel}=ω_{wheel}*r_{wheel}

v_{bike}=ω_{backwheel}*r_{backwheel}=ω_{wheel}*r_{backwheel}

In some embodiments, v_{bike} equation above can be used to determine a bike velocity of a bike with a fixed gear ratio. In an embodiment, if the bike has a fixed gear ratio (i.e., no alternating gears), the rider may be prompted to answer a few questions by the virtual coach in addition to the characteristics measured by the pedal sensor. For example, in one embodiments, the rider can enter characteristics of the bike into the virtual coach. The characteristics of the bike may include a ratio of a radius of the flywheel 460 to a radius of the backwheel 470. The characteristics of the bike may further include a bike model type and a serial number. In some embodiments, the virtual coach can be configured to look up additional bike characteristics based on the entered model type and serial number. For example, the virtual coach may look up bike characteristics via an connection to the internet. Additionally, in some embodiments, the rider can enter physical characteristics, such as age, gender, and weight.

In some embodiments, a pedal sensor can transmit the bike speed to a virtual coach. In one embodiment, the pedal sensor can include a inertial measurement unit (IMU). The output of the pedal sensor can include at least a pedal speed, a crank shaft speed, and a bike speed. In other embodiments, the virtual coach can perform the calculations without the pedal sensor. For example, in one embodiment, a virtual coach can be an application executing on a smartphone. The smartphone can have an embedded inertial measurement unit (IMU). The virtual coach can utilize the IMU of the smartphone to calculate bike speed. For example, the IMU may include a gyroscope and an accelerometer, which can be utilized to derive a bike speed during a cycling session outdoors. In such an embodiment, the virtual coach can receive measurements from the pedal sensor to calculate a current gear ratio.

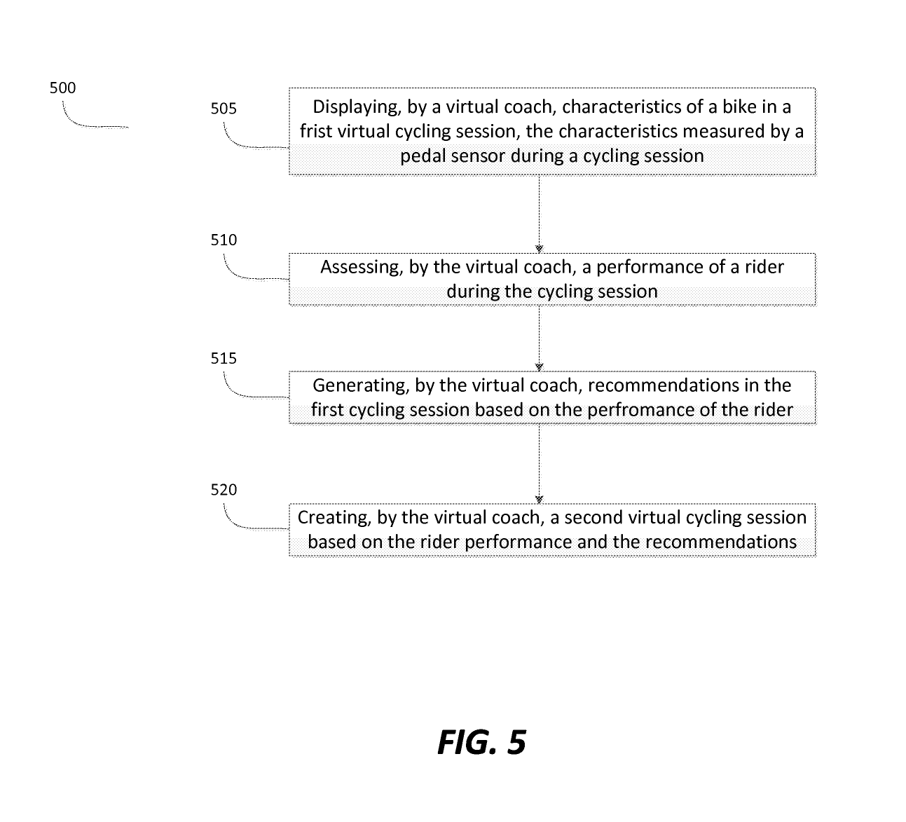

FIG. 5 depicts an illustration of the steps taken in one embodiment of a method for monitoring and providing recommendations to a rider during a cycling session. In a brief overview, the method 500 can include displaying, by a virtual coach, characteristics of a bike in a first virtual cycling session, the characteristics measured by a pedal sensor during a cycling session (505). The virtual coach can assess a performance of a rider during the cycling session (510) and generate recommendations in the first virtual cycling session based on the performance of the rider (515). The virtual coach can create a second virtual cycling session based on the rider performance and the recommendations (520).

In some embodiments, the method 500 includes displaying, by a virtual coach, characteristics of a bike in a first virtual cycling session (505). In an embodiment, the display can be an interactive map. In some embodiments, the display can be a display for a hand-held computing device. In one embodiment, the display can be a display of a smart-phone. In other embodiments, the display can be coupled to a wearable computer device.

In an embodiment, the characteristics can be measured by a pedal sensor during a cycling session. In some embodiments, the characteristics can be transmitted from the pedal sensor to the virtual coach. In an embodiment, the characteristics can include at least one of a crank angle, a pedal angle, and a bike speed. In one embodiment, the virtual coach can store data related to a cycling accident.

In some embodiments, the method 500 further includes receiving, by the virtual coach, a heart rate measurement of the rider during a cycling session from a heart rate sensor. In embodiment, the virtual coach can display a heart rate of a rider during a cycling session. The heart rate can be transmitted from a heart rate sensor to the virtual coach. In an embodiment, the heart rate sensor can be communicatively coupled to the virtual coach. In some embodiments, the heart rate sensor can be worn by a rider, for example, around the rider's wrist or around the rider's chest. In some embodiments, the method 500 can further include receiving, by the virtual coach, a force measurement from a force sensor. In an embodiment, the virtual coach can display a force measurement. The force sensor may include any type of force or pressure measurement instrument, for example, a load cell, a pressure map, and a strain gauge. The force sensor may be coupled to various components of the bike, for example, the pedal, the rear wheel, the front wheel, and the main frame of the bike.

In some embodiments, the method 500 further includes receiving, by the virtual coach, a total distance traveled during the cycling session. In an embodiment, the virtual coach can display a distance traveled during a cycling session. In an embodiment, the virtual coach can be communicatively coupled to a GPS device. In an embodiment, the GPS device can be a component of the virtual coach. The GPS device may be configured to determine a distance traveled during a cycling session and transmit the distance traveled to the virtual coach. In some embodiments, the method 500 further includes receiving, by the virtual coach, a time value for a cycling session. In an embodiment, the virtual coach can display the time value. In some embodiments, the time value may include an elapsed time during the cycling session.

In some embodiments, the virtual coach can display a gear ratio. In an embodiment, the virtual coach can display a recommended gear ratio to the rider based on the selected cycling session. In some embodiments, the virtual coach can display a bike speed. In an embodiment, the bike speed can be determined based on the characteristics of the bike, such as the methods described above with respect to FIGS. 4A and 4B. In some embodiments, the virtual coach can display calories expended. In other embodiments, the virtual coach can display an estimated calories expenditure value for a cycling session.

In some embodiments, the virtual coach can display a road angle. In an embodiment, the virtual coach can measure a road angle, for example, to determine if the bicycle is going uphill or downhill. In some embodiments, the virtual coach can display a bike balance or a rider balance. In an embodiment, the virtual coach can determine a bike balance or rider balance during a cycling session. In one embodiment, the bike balance or rider balance can detect a right deviation or a right deviation

In some embodiments, the display may be a touch screen for a rider to enter information and characteristics. For example, in an embodiment, the rider may enter physical characteristics such as height, weight, resting heart rate, age, and/or gender. In other embodiments, the rider may enter characteristics of the bike such as a model type, serial number, a ratio of a flywheel to a backwheel of the bike. The virtual coach may display the information provided by the rider.

In some embodiments, the method 500 can include assessing, by the virtual coach, a performance of a rider during the cycling session (510). In an embodiment, the virtual coach can make an assessment on the performance of the rider based on the received characteristics of the bike. In one embodiment, the virtual coach may compare the received characteristics to pre-determined threshold values. In one embodiment, the threshold values may be generated and entered into a database by the rider prior to the cycling session. In other embodiments, the threshold values may be generated by an independent coach. In still other embodiments, the threshold values may be entered by an administrator of the virtual coach system. The threshold values may represent minimum or maximum performance standards of various characteristics of a cycling session. For example, in some embodiments, the threshold values may indicate if the rider is not working hard enough, working too hard, and/or if the rider is operating the bike inefficiently (e.g., pedaling too fast).

In an embodiment, the virtual coach may compare the characteristics to historical data representing past cycling sessions of the rider. In some embodiments, the virtual coach can store characteristics for past performances by the rider. The virtual coach can determine patterns or target ranges for each of the measurable characteristics based on how the rider performed in the past. For example, in one embodiment, the virtual coach can determine an appropriate gear ratio for the rider based on past cycling sessions. In some embodiments, the virtual coach can determine if a current gear ratio the rider is in is below gear ratios of past performances, above past performances, or in an allowable range based on the determined target range. In one embodiments, the target range can be based on the type of bike the rider is operating or the environmental conditions the rider is operating the bike in. In some embodiments, the virtual coach can assess a performance of the rider based on a combination of threshold values and historical data. In an embodiment, the threshold values can be determined by analyzing the historical data of the rider.

In some embodiments, the virtual coach can provide audio alerts to a rider. In an embodiment, the virtual coach can generate audio alerts to the rider during a cycling session. In one embodiment, the audio alert can be indicate to the rider that they have reached or passed a threshold value in the cycling session. For example, the audio alerts can designed to alert a rider when they have passed a pre-determined distance threshold. In another embodiment, the audio alert can indicate to a rider when the current gear ratio is not in the recommended gear ratio range. In still another embodiment, the audio alert can indicate to a rider when their current heart rate is out of a recommended range. In an embodiment, the audio alerts can be configured by a rider for any measurable characteristic related to the cycling session. In some embodiments, the threshold levels for audio alerts can be created based upon historical data related to the rider and standard threshold values.

In some embodiments, the virtual coach can continuously communicate with a transceiver. In an embodiment, the transceiver can be a component of or located on another bicycle and/or in a motor vehicle. In some embodiments, the transceiver can transmit information related to the bicycle or motor vehicle. For example, in an embodiment, the transceiver may transmit information including at least one of position information, velocity information, and destination information. In some embodiments, the virtual coach can generate alerts to a rider based on the information received from the transceiver.

In some embodiments, the method 500 can include generating, by the virtual coach, recommendations in the first virtual cycling session based on the performance of the rider (515). In an embodiment, the recommendations can be generated in response to assessing the performance of the rider during a cycling session. In some embodiments, the virtual coach can generate recommendations for a cycling session for at least one of a bike speed, a gear ratio, a calorie expenditure value, a heart rate, a distance, a time, a bike posture, and a cycling route.

In one embodiment, the recommendations may be generated to teach the rider to operate the bike more efficiently and to improve the cycling session experience for the rider. For example, in some embodiments, the virtual coach can recommend an appropriate gear ratio for a rider during cycling session. The virtual coach may determine a current gear ratio. The virtual coach may compare the current gear ratio to a threshold value, historical data, or both and determine if the rider is operating in an acceptable range. The virtual coach can then generate a recommended gear ratio to the rider. The recommended gear ratio may be faster or slower than the current gear ratio. In other embodiments, the recommended gear ratio may be the same gear ratio the rider is using, for example, if the rider is operating efficiently.

In some embodiments, the virtual coach can determine a road angle during the cycling session. The virtual coach can measure a road angle, for example, to determine if the bicycle is going uphill or downhill. Additionally, the virtual coach 650 can be configured to measure a bike balance or rider balance. For example, in some embodiments, the virtual coach can determine if the rider is pedaling too fast or too hard with one foot versus the opposite foot resulting in either a right deviation or left deviation. In response, the virtual coach can generate a recommendation to instruct the rider to pedal slower with one foot or faster with the other foot. In some embodiments, the virtual coach can recommend a posture for a rider during the cycling session. In an embodiment, the virtual coach can determine a posture of a rider on the bike during the cycling session. In some embodiments, to determine the posture, the virtual coach can compare measurements a left pedal sensor to measurements of a right pedal. In response, the virtual coach may recommend proper posture for the rider during the cycling session.

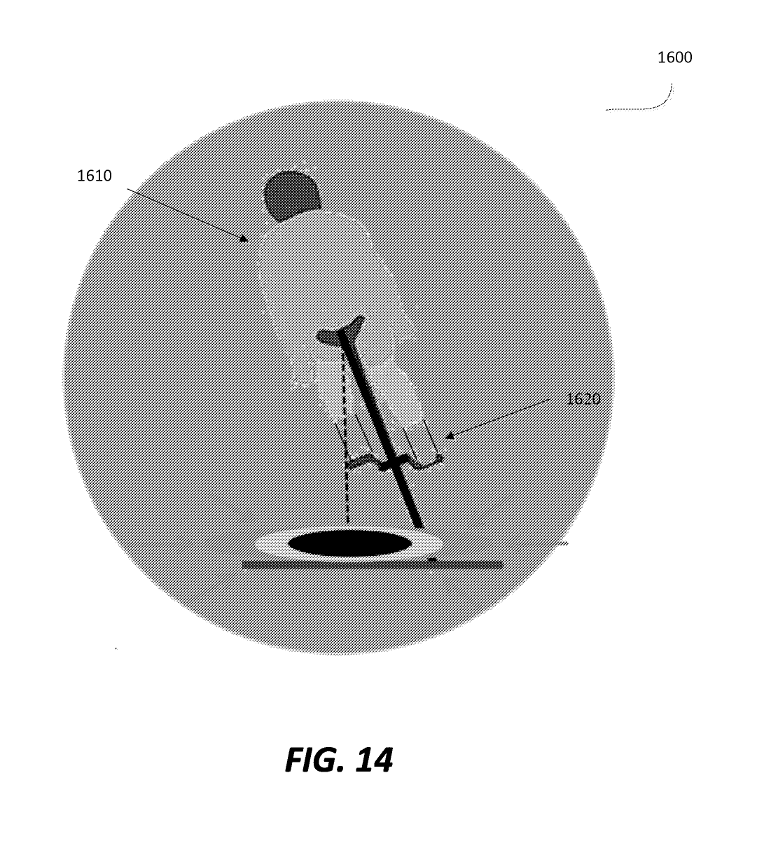

FIG. 14 depicts an illustration of an embodiment of an unstable rider detection 1600. In more detail, FIG. 14 depicts a rider 1610 on a bike 1620 in an unstable position. In some embodiments, the rider 161 may be a child or any person new to operating the bike 1620. In an embodiment, the rider can be an experienced rider. In some embodiments, the virtual coach can detect an instability of the rider 1610 during the cycling session. In an embodiment, the virtual coach can generate corrections for the rider 1610 to teach the rider 1610 a correct way of cycling in response to the posture of the rider 1610. In one embodiment, the virtual coach can generate audio, visual, and or tactile alerts to the rider to alert them to the unstable position. In an embodiment, the rider 1610 can learn to ride the bike 1620 correctly in response to the commands from the virtual coach. In some embodiments, the virtual coach can tutor the rider 1610 on how to ride the bike 1620 to teach them how to operate the bike 1620.

In some embodiments, the virtual coach may use the determined road angle to recommend a calorie expenditure or a work done value for a cycling session. In an embodiment, the calorie expenditure or the work done value may be the number calories burnt by a rider during the cycling session. In an embodiment, the virtual coach may generate a calories expenditure amount for a new cycling session based at least on the recommended gear ratio. In some embodiments, the virtual coach can use the road angle measurement and together with the heart rate data and the bike speed data received from the pedal sensor, prove an estimated calories expenditure value for a rider.

In some embodiments, the virtual coach can recommend alternate cycling routes for the rider. In one embodiment, the alternate cycling routes may be based on past cycling routes used by the rider. The past cycling routes may be stored in the virtual coach and include GPS mapping of the route. In some embodiments, the virtual coach can generate the alternate cycling routes for the rider. In an embodiment, the virtual coach can generate the alternate cycling routes based on the performance of the rider during the cycling session. In still another embodiment, the virtual coach can generate alternate cycling routes based on previously stored data related to the rider. The previously stored data can represent past cycling sessions and virtual cycling sessions. In some embodiments, the virtual coach can generate alternate cycling routes based on a combination of the performance of the rider and previously stored data. In an embodiment, the more often a rider utilizes the virtual coach, the virtual coach can develop more efficient and better training routes for the rider. In some embodiments, the virtual coach can generate different alternate cycling routes for two different riders, based on rider's different stored performances.

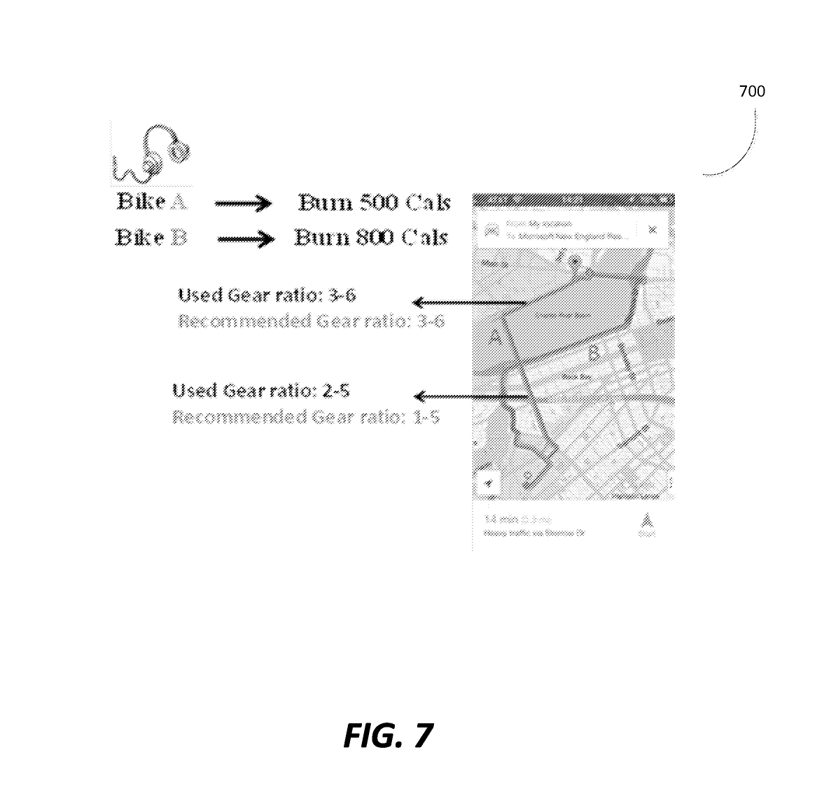

In some embodiments, the method 500 can include creating, by the virtual coach, a second virtual cycling session based on the rider performance and the recommendations (520). In an embodiment, the virtual coach may create a second virtual cycling session based on the recommendations generated. For example, in one embodiment, the second virtual cycling session may include recommendations generated by the virtual coach for a new cycling route with a recommended gear ratio, and an expected calorie expenditure, similar to the display illustrated in FIG. 7.

In other embodiments, the virtual coach may generate the second virtual cycling session based on the assessment of the rider performance. In some embodiments, the virtual coach may generate the second virtual cycling session based on both the recommendations generated and the assessment of the rider's performance. In an embodiment, the virtual coach may create the second virtual cycling session to coach the rider and change the rider's cycling habits. In one embodiment, the virtual coach may train the rider to be more efficient when operating a bike based upon the created second virtual cycling session and additional virtual cycling sessions.

In one embodiment, the second virtual cycling session may correspond to or be based upon the alternate cycling routes generated by the virtual coach. In some embodiments, the more often a rider utilizes the virtual coach, the virtual coach can develop and create more efficient and better training routes for the rider based on a greater amount of historical data. In an embodiment, the virtual coach can generate different alternate cycling routes for two different riders, based on rider's different stored performances.

In some embodiments, the virtual coach can generate a third virtual cycling session. In an embodiment, the third cycling session can be based on the performance of the rider during the first cycling session and the second cycling session. In some embodiments, the virtual coach can continue to generate new virtual cycling sessions. Each new virtual cycling session can be based on past performances recorded by the virtual coach.

In some embodiments, the virtual coach may generate the second virtual cycling session based on a prompt from the rider. In one embodiment, the second virtual cycling session may be created upon activating and/or turning on the virtual coach system. In some embodiments, the virtual coach can generate a third virtual cycling session. In an embodiment, the third cycling session can be based on the performance of the rider during the first cycling session and the second cycling session. In some embodiments, the virtual coach can continue to generate new virtual cycling sessions. Each new virtual cycling session can be based on past performances recorded by the virtual coach. In some embodiments, the virtual coach can teach the rider to ride more efficiently by generating new cycling sessions with appropriate recommended measurable characteristics such as gear ratio, bike speed, and distances. In an embodiment, by providing more efficient cycling sessions to the rider, the virtual coach can coach a rider and change their cycling habits.

In some embodiments, the virtual coach further includes a learning module. In one embodiment, the learning module may include advanced machine learning algorithms. In some embodiments, the learning module can track behavior characteristics of the rider. The more a rider uses the virtual coach, the more information the virtual coach can analyze and track. In an embodiment, the learning module can generate exercise goals for the rider based on the behavior characteristics. In some embodiments, the virtual coach can be an everyday interface. In an embodiment, the virtual coach can be an everyday interface with the rider, to learn the rider's behavior and habits and generate recommendations to achieve certain exercise goals for the rider.

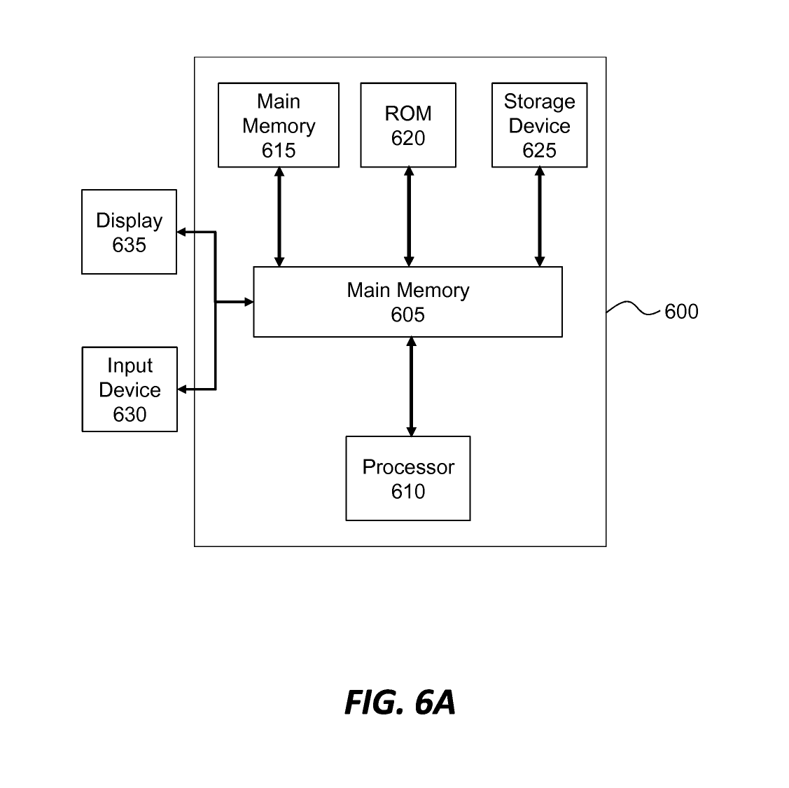

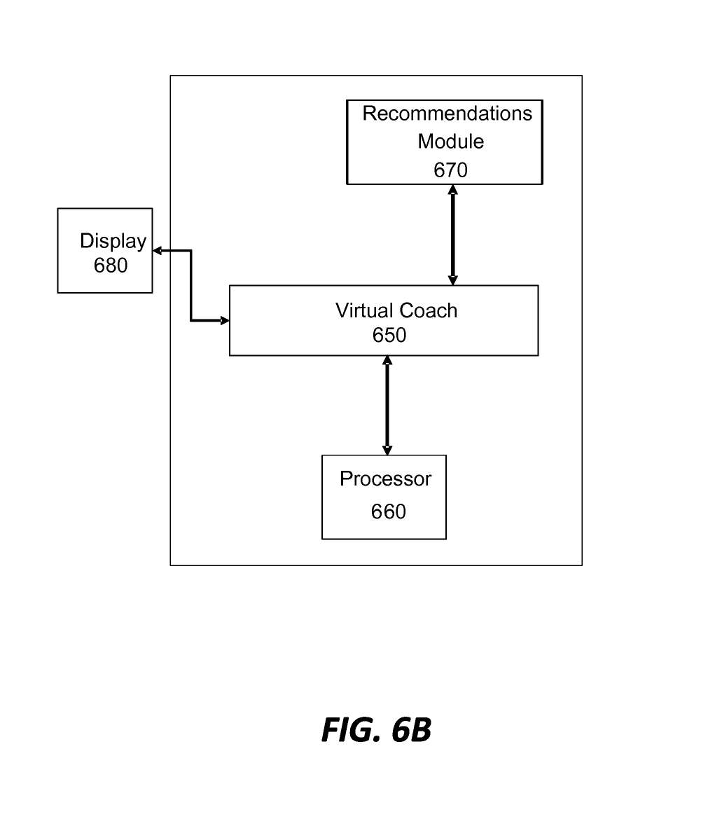

FIG. 6 is a block diagram illustrating a general architecture for a computer system that may be employed to implement various elements of the systems and methods described herein, in accordance with an embodiment. In some embodiments, computer system 600 may be employed to implement one or more aspects of the virtual coach as described in relation to FIG. 1. For example, some or all of measured characteristics of a bike can be stored in a data structure in memory element 605. Upon receiving input via the input device 630, processor 610 can access the data structure stored in memory element 605 and display, execute, perform, or otherwise assess the performance of a rider during a cycling session based on the received characteristics of the bike. In some embodiments, the processor 610 may generate recommendations for alternate cycling sessions based on a rider performance and output this information via a display 635 or other networked device.

In some embodiments, the processor 610 may prompt or otherwise request a rider to provide additional information to facilitate monitoring the rider during a cycling session. In some embodiments, the virtual coach 600 may be configured to receive characteristics of a bike. For example, a rider may enter a ratio of the flywheel to the backwheel of the bike the rider is operating, as well as a model type of the bike. In an embodiment, the virtual coach 600 may be configured to receive additional information related to the rider. For example and without limitation, a rider may enter physical characteristics such as height, weight, resting heart rate, age, and/or gender. Recommendations

The virtual coach 600 may execute on a device such as that depicted in FIG. 6. The virtual coach 600 can include a bus 605 or other communication component for communicating information and a processor 610 or processing circuit coupled to the bus 605 for processing information. The virtual coach 600 can also include one or more processors 610 or processing circuits coupled to the bus for processing information. The virtual coach 600 also includes main memory 615, such as a random access memory (RAM) or other dynamic storage device, coupled to the bus 605 for storing information, and instructions to be executed by the processor 610. Main memory 615 can also be used for storing position information, temporary variables, or other intermediate information during execution of instructions by the processor 610. The virtual coach 600 may further include a read only memory (ROM) 620 or other static storage device coupled to the bus 605 for storing static information and instructions for the processor 610. A storage device 625, such as a solid state device, magnetic disk or optical disk, is coupled to the bus 605 for persistently storing information and instructions.

The virtual coach 600 may be coupled via the bus 605 to a display 635, such as a liquid crystal display, or active matrix display, for displaying information to a user. In one embodiment, the display 635 may be an interactive display. For example, the display 635 may be a touchscreen. An input device 630, such as a keyboard including alphanumeric and other keys, may be coupled to the bus 605 for communicating information and command selections to the processor 610. In another implementation, the input device 630 has a touch screen display 635. The input device 630 can include a cursor control, such as a mouse, a trackball, or cursor direction keys, for communicating direction information and command selections to the processor 610 and for controlling cursor movement on the display 635.

According to various implementations, the processes described herein can be implemented by the virtual coach 600 in response to the processor 610 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes described herein. One or more processors in a multi-processing arrangement may also be employed to execute the instructions contained in main memory 615. In alternative implementations, hard-wired circuitry may be used in place of or in combination with software instructions to effect illustrative implementations. Thus, implementations are not limited to any specific combination of hardware circuitry and software.

Although an example virtual coach has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

FIG. 6B is a block diagram illustrating an embodiment of a virtual coach system 650. In some embodiments, the virtual coach 650 can include all of the components and capabilities described above with respect to the computer system 600. The virtual coach 650 includes a processor 660, a recommendations module 670, and a display 680. In an embodiment, the virtual coach may further include a speaker. In some embodiments, the virtual coach 650 is communicatively coupled to a pedal sensor, for example, the pedal sensor as described herein (e.g., FIGS. 3A-3B). In an embodiment, the virtual coach 650 can include an inertial measurement unit (IMU), an accelerometer, and/or a gyroscope. The virtual coach 650 can be configured to measure a road angle, for example, determine if the bicycle is going uphill or downhill. Additionally, the virtual coach 650 can be configured to measure a bike balance or rider balance, for example, a right deviation or left deviation. In some embodiments, the virtual coach 600 is battery operated. In an embodiment, the virtual coach 650 can be an application executing on a hand-held computing device such as a smartphone.

In an embodiment, the processor 660 may be configured to receive data from the pedal sensor. In some embodiments, the processor may be configured to transmit the data from the pedal sensor to the recommendations module 680. In some embodiments, the processor 660 is configured to transmit the data to the display 690, for example, as illustrated in FIG. 7. In some embodiments, the characteristics can be measured by a pedal sensor during a cycling session. In an embodiment, the virtual coach 650 can be configured to assess a performance of a rider during the cycling session. The virtual coach 650 can be configured to generate recommendations in the first virtual cycling session based on the performance of the rider. In some embodiments, the recommendations module 670 can be configured to generate the recommendations. The recommendations module 670 may include a memory to store and record past performances of the rider. In some embodiments, the virtual coach 650 can be configured to create a second virtual cycling session based on the rider performance and the recommendations.

In some embodiments, the display 680 is an interactive map. In an embodiment, the virtual coach 650 can be configured to receive characteristics of the bike from a pedal sensor. In some embodiments, the characteristics include at least a pedal angle, a crank shaft angle, and bike speed. In some embodiments, the virtual coach can be configured to determine a current gear ratio of the bike. In an embodiment, the virtual coach 650 can be configured to determine a road angle during the cycling session. In some embodiments, the virtual coach is configured to determine a posture of the rider on the bike during the cycling session based on the road angle. In an embodiment, the virtual coach can be configured to detect an instability of the rider during the cycling session. In some embodiments, the virtual coach can be configured to generate corrections for the rider to teach the rider a correct way of cycling in response to the posture of the rider. In one embodiment, the virtual coach can be configured to tutor a new rider on how to ride the bike.

In some embodiments, the virtual coach 650 is configured to generate alternate cycling routes for the rider based on the performance of the rider during the cycling session. In an embodiment, the recommendations module 670 can be configured to generate alternate cycling routes for the rider based on the performance of the rider during the cycling session and transmit them to the virtual coach 650. In some embodiments, the alternate cycling routes can include recommendations for at least one of a bike speed, a gear ratio, and an estimated calories burnt during the alternate cycling routes. In some embodiments, the virtual coach 650 is configured to generate a third virtual cycling session, the third virtual cycling session based on the performance of the rider during the first cycling session and the second cycling session. In an embodiment, the recommendations module 670 can be configured to generate a third virtual cycling session, the third virtual cycling session based on the performance of the rider during the first cycling session and the second cycling session.

In some embodiments, the virtual coach 650 is configured to display characteristics of a bike in a first virtual cycling session. The characteristics can be displayed on the display 680, for example as illustrated in FIG. 7.

In more detail, FIG. 7 depicts an illustration of an embodiment of output of a virtual coach. The display 680 can provide alternate cycling routes. In FIG. 7, the rider is offered two alternate cycling routes. The virtual coach 650 can calculate an estimated calorie output by a rider and a recommended gear ratio to produce the desired calorie amount and provide it to the rider on the display 680. The virtual coach can also output an average gear ratio for past performances along the same route to teach the rider whether they have been cycling to hard in the past or to easily. For example, during the first route, indicated by “Bike A,” the rider is estimated to burn 500 calories and the recommended gear ratio is 3-6. The display 680 also indicates that the rider has previously used a gear ratio average between 3-6. The second route, indicated by “Bike B,” the rider is estimated to burn 800 calories and the recommended gear ratio is 1-5. However, the output from the virtual coach also indicates the average gear ratio from past cycling sessions is 2-5. The knowledge of past cycling sessions allows the virtual coach to teach a rider to ride more efficiently and coach them the more the system is utilized.

In some embodiments, recommendations module 670 and the processor 660 are configured to perform the operations of the virtual coach 650. In an embodiment, the recommendations module 670 is configured to receive data from a pedal sensor. In an embodiment, the electronics module may process the data and transmit the data to the display 680. In one embodiment, the display 680 may be a display of a smartphone. In some embodiments, the recommendations module 670 can be coupled to a GPS system. In an embodiment, the GPS system may be a component of the virtual coach 650. The GPS system may be configured to determine a distance traveled during a cycling session. In some embodiments, the recommendations module 670 may be configured to compute the present cycling characteristics. The current characteristics, for example and without limitation, may include, heart rate, traveled distance, elapsed time, bike speed, and calories burnt.

In some embodiments, the virtual coach 650 can include a user interface for a rider to enter information. In some embodiments, the virtual coach 650 can include a heart rate module. In an embodiment, the heart rate module may be communicatively coupled to the virtual coach 650. The heart rate module may be worn by a rider, for example, a rider's wrist or around the rider's chest.

In some embodiments, the virtual coach 650 may include a force sensor. The force sensor may include any type of force or pressure measurement instrument, for example, a load cell, a pressure map, and a strain gauge. The force sensor may be coupled to various components of the bike, for example, the pedal, the rear wheel, the front wheel, and the main frame of the bike.

In some embodiments, the virtual coach 650 includes an inertial measurement unit (IMU). The IMU may be embedded in the virtual coach 650. The IMU may include at least one of an accelerometer and a gyroscope. In an embodiment, the virtual coach 650 can measure the bike speed (i.e., velocity) independent of a pedal sensor. In some embodiments, the calculated bike speed can be transmitted to the recommendations module 670.

Interactive Cyclist Monitoring and Crash Prevention System

The present application may further be directed towards a modular accessory for a bicycle so as to make the cycling exercise safer on the streets. A proximity sensor system can be composed of three parts: a front console, a back console and a computer-based application. In some embodiments, the front and back consoles can be removable attachments that will be installed on the steering wheel and seat post, respectively. In an embodiment, the front and back consoles can be integrated with line-lasers, proximity sensors, vibrators, LEDs and speakers. In some embodiment, each console may include two line-lasers to project a virtual bike lane on the ground. Additionally, in an embodiment, a pair of proximity sensors can be integrated into each console to detect objects around the cyclist. In some embodiments, the speaker can alert the cyclist in case of any dangerous situation. Additionally, in an embodiment, by using a series of LEDs, the back console can provide the signaling and the front console can illuminate the road ahead.

In some embodiments, a virtual coach system can include a proximity sensor system. In an embodiment, a virtual coach can be configured to receive an alert from a proximity sensor system. In an embodiment, the proximity sensor system can detect a relationship between a bike and objects around the bike. In some embodiments, the proximity sensor system sensor can be interfaced with a virtual coach, for example, the virtual coach described with respect to FIG. 6A and FIG. 6B. In some embodiments, the proximity sensor system can consist of two major components: a front console and a back console.

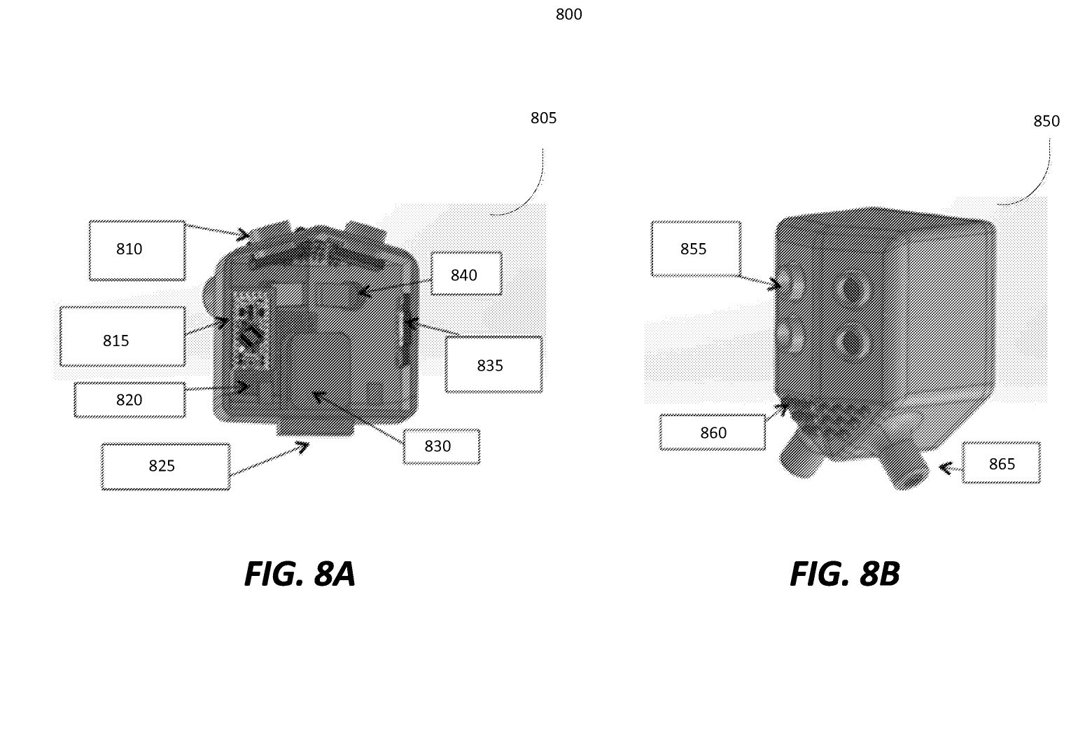

FIG. 8A depicts an illustration an embodiment of a cutaway view of a front sensor console 805 for a safety sensor system 800. In some embodiments, the front console 805 can be attached to a handle bar section of the bike. In an embodiment, the front console 850 can include two proximity sensors 810, two laser lights 840, a mounting clip 825, a vibrator, a flashlight, a speaker, a wireless component, a single-board microcontroller 815, and one switch 820. The wireless component 835 may be a wireless link and may include BLUETOOTH or Wi-Fi. In some embodiments, the wireless links may include any cellular network standards sued to communicate among mobile devices, including standards that qualify as 1G, 2G, 3G, or 4G. In an embodiment, the single-board microcontroller 815 can be an Arduino Board such as those manufactured by Arduino LLC.

In some embodiments, the switch 820 can be used by the rider to indicate if they are turning. In an embodiments, the switch 820 can send a signal for the laser lights 840 to flash to the side the rider is turning. In some embodiments, the Bluetooth components 835 can be used to make the system wireless. In an embodiment, the single-board microcontroller 815 can be used to program the other components of the proximity sensor system.

In some embodiments, the safety sensor system 800 may be a smart phone based application such as an IPHONE device manufactured by Apple Inc. In an embodiments, the smart phone application can be created to serve as a communication device by showing the locations of all the riders that are using the application for anyone logged into the application. In an embodiment, the smart phone application can alert a rider of other cyclists in the area. Additionally, in some embodiments, the smart phone application can execute on a car's GPS system to alert drivers of cyclists on the road. In an embodiment, the smartphone can be coupled to the handlebar via the mounting clip 825. In some embodiments, the mounting clip 825 can be a phone holster. In some embodiments, the phone holster can be a smartphone mount on a bicycle's handlebar so that the rider can use a GPS system while cycling and the application can collect the data. In other embodiments, If the user does not want to use the mounting clip 825, the application can still collect data. For example if the application is executing on a smartphone in the rider's pocket or backpack.

FIG. 8B depicts an illustration of an embodiment of a back console 850 for a safety sensor 800. In an embodiment, the back console 850, can be attached at the back of the bicycle seat. In some embodiments, the back console can include two proximity sensors 855, two laser lights 860, one wireless component, one single-board microcontroller, and LED lights 865. The wireless component and the single-board microcontroller may be similar to those described above with respect to FIG. 8A. In some embodiments, the LED lights 865 may be used a signal indicators to alert vehicles, other cyclists or people behind the rider of an upcoming turn.

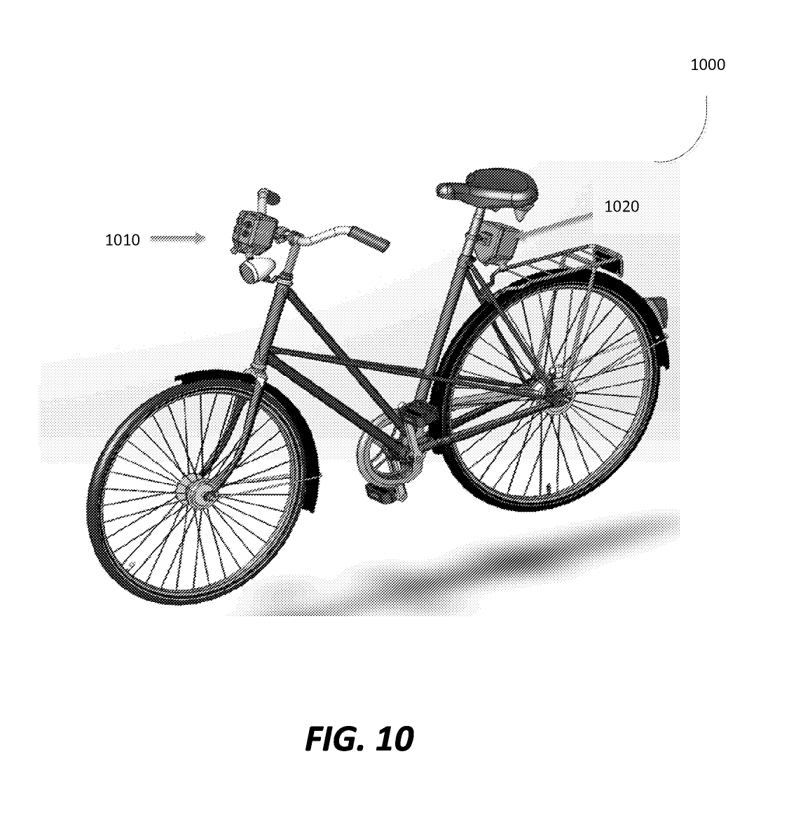

FIG. 10 depicts an illustration of an embodiment of a safety sensor system 1000 coupled to a bike. The safety sensor 1000 includes a front sensor 1010 and a back console 1020. In some embodiments, the front console 1010 is coupled to the handlebars of the bike. In some embodiments, the back console can be coupled to a seat shaft of the bike.

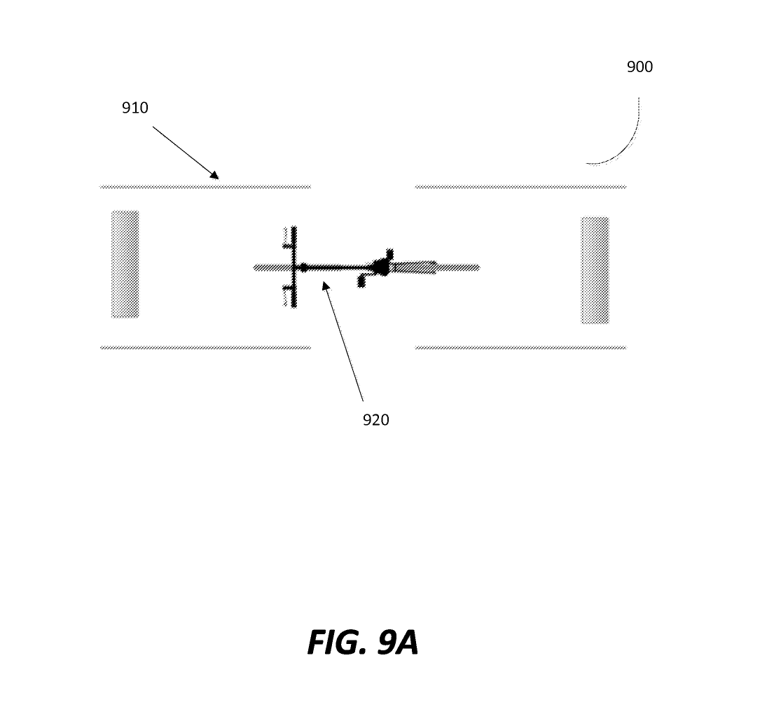

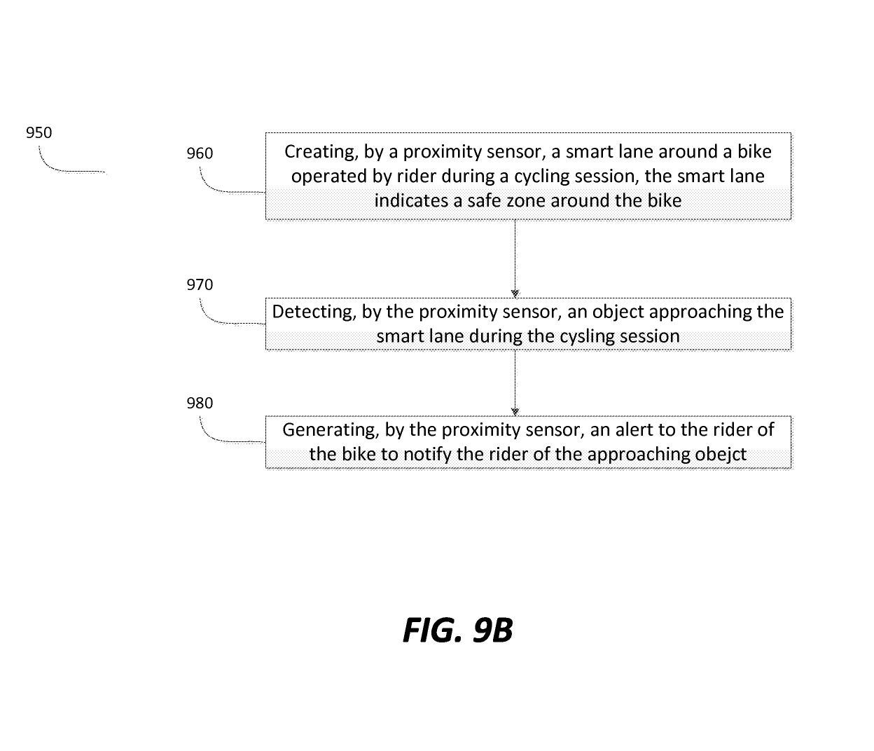

FIG. 9A depicts an illustration of an embodiment of a visual alert system 900. In some embodiments, the laser lights 840, 860 can be used to project the smart lane 910 on the ground. In an embodiment, the laser lights 840, 860 may emit green lights onto a surface (e.g., street, sidewalk) around the bike 920 the rider is operating, as illustrated in FIG. 9A. In one embodiment, the smart lane 910 can be transmitted to a computing device to create a virtual lane on a display of the computing device. The computer device may be coupled the bike 920 or to the rider during a cycling session, for example those computing devices described herein. The laser lights 840 may be configured to emit any color onto a surface.

In some embodiments, the proximity sensors 810, 855 can interact with the light lights 840, 860 to increase the awareness of both the bike as well as any nearby drivers. For example, in an embodiment, the proximity sensor system 800 may detect a nearby vehicle or external danger and will trigger a change in the laser lights' 840, 860 behavior (e.g., change in color, flashing lights, etc.). The operator of the vehicle may notice the change in the laser lights 840, 860 behavior and be alerted to the presence of the cyclist.

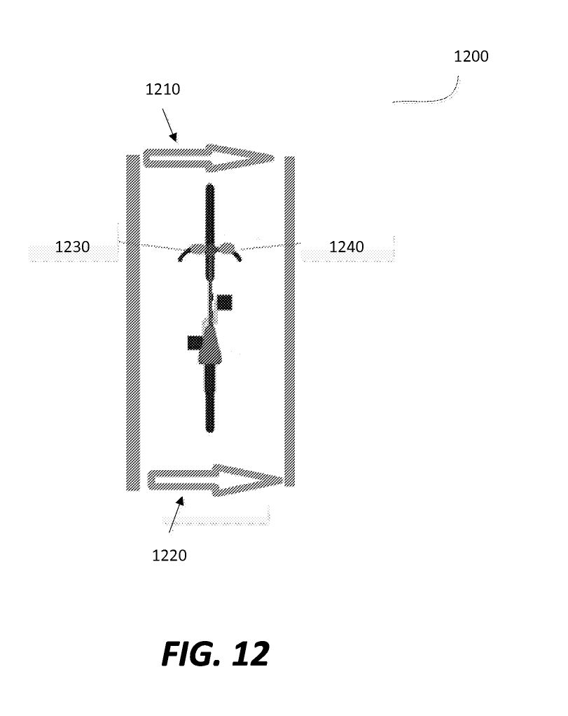

FIG. 12 depicts an illustration of one embodiment of a visual alert 1200. In some embodiments, the safety sensor can include components for the visual alert 1200. In an embodiment, the safety sensor can be include a motion detector 1230 and an audio receiver/transmitter 1240. Further, in some embodiments, the visual alert 1200 can generate a front signal arrow 1210 and a rear signal arrow 1220. In an embodiment, the safety sensor system may detect an upcoming intersection and the front signal arrow 1210 may indicate to the rider to take the appropriate turn at the intersection. In such an embodiment, the back arrow may indicate the turn the rider is about to make to another cyclist behind them or to a motor vehicle. In some embodiments, the audio receiver/transmitter 1240 can emit audio commands to the rider, for example “left turn ahead” to coincide with the display of the front arrow 1210 in front of the rider and the back arrow 1220 in back of the rider. In other embodiments, the rider can swipe their hand in front of the motion sensor 1230 to indicate a turn they expect to make. In such embodiments, the visual alert 1200 can generate appropriate front arrows 1210 and back arrows 1220 to indicate the expected turn the rider anticipates making.

In some embodiments, the visual alert 1200 can indicate to other cyclists and motor vehicles when the rider is slowing down. In an embodiment, the visual alert 1200 can indicate slowing down by displaying the arrows in a red light, similar to brake lights on a motor vehicle. In some embodiments, the visual alert 1200 can generate any range of symbols, characters, and/or numbers to indicate characteristics of the bike to other cyclists and motor vehicles around the bike. In an embodiment, the safety sensor can include automated signaling capabilities. In an embodiment, the rider can set a destination, for example in a smartphone GPS, at the beginning of a trip or cycling session. In one embodiment, the safety sensor can determine the intended cycling route and pre-program appropriate signals, front arrows and back arrows, to correspond with the anticipated turns to reach the destination. In some embodiments, the safety sensor can generate the appropriate front arrow and back arrow based on the intended destination independent of rider interaction. In such an embodiment, the safety sensor can generate arrows at intersections without a rider indicating which way they intend to turn.

In some embodiments, the front console 805 and the back console 850 each include at least two lasers 840, 860. In an embodiment, the two lasers 840, 860 can be placed at a length of about 5 feet from each other. A length can be selected, such that the proper angle is created to maximize the design's efficiency. For example, estimating the consoles would be about 3 feet above the ground, to detect cars from at least 15 feet behind and 5 feet to the left or right of the bicycle, an ideal angle was found to be about 37 degrees in between the two sensors

In some embodiments, the main component of both the front console 805 and the back console 850, can be an ultrasonic sensor or any kind of wave and light sensor which can detect approaching objects to the cyclist. In some embodiments, there will be a transceiver module integrated in the proximity sensor system 800 to send the data to the virtual coach system, for example the virtual coach system as described in FIG. 6. In an embodiment, the proximity sensor system 800 can be powered by batteries and controlled by an on/off switch. In some embodiments, the battery can be recharged by the power generated by the rider by applying force to the pedal. In an embodiment, to save energy, the proximity sensor can automatically turn on with a movement detector and will turn off when no movement is detected within a pre-determined range of time, for example 5 minutes.

In some embodiments, the front console 805 and the back console 850 may weigh no more than 0.6 lb. each. The proximity sensor system 800 features can be fabricated to fit onto any type bike model. In some embodiments, the electric components including lights and sensors can be of low energy consumption and can be fitted in a custom lightweight housing adaptable to all bike types. Additionally, in an embodiment, the proximity sensor systems 800 may include waterproof housing.

FIG. 9B depicts an illustration of the steps taken in one embodiment of a method 950 for monitoring and crash prevention for a rider during a cycling session. In a brief overview, the method 950 may include creating, by the safety sensor, a smart lane around a bike operated by a rider during a cycling session, the smart lane indicates a safe zone around the bike (960). The method may further include detecting, by the safety sensor, an object approaching the smart lane during the cycling session (970). The method 950 may further include generating, by the safety sensor, an alert to the rider of the bike to notify the rider of the approaching object (980).

In some embodiments, the method 950 may include creating, by the safety sensor, a smart lane around a bike operated by a rider during a cycling session, the smart lane indicates a safe zone around the bike (960). In some embodiments, the safety sensor s can interact with the laser lights, such as laser lights 840, 860 described above with respect to FIG. 9A, to increase the awareness of both the bike as well as any nearby drivers. For example, in an embodiment, the safety sensor may detect a nearby vehicle or external danger and will trigger a change in the laser lights' 840, 860 behavior (e.g., change in color, flashing lights, etc.). The operator of the vehicle may notice the change in the laser lights 840, 860 behavior and be alerted to the presence of the cyclist.

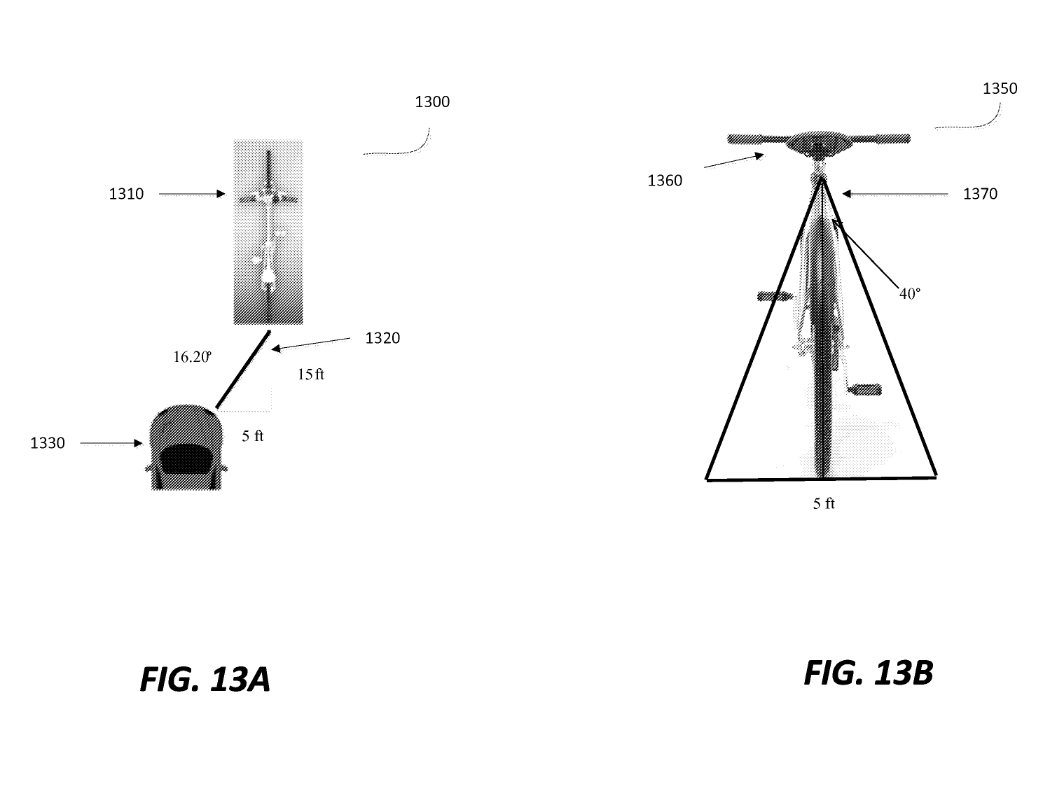

In some embodiments, the method 950 may include detecting, by the safety sensor, an object approaching the smart lane during the cycling session (970). In some embodiments, the safety sensor may detect an approaching object (e.g., a vehicle) within a certain distance from the bike. FIG. 13A depicts an illustration of an embodiment of a range of detection 1300. In more detail, FIG. 13A depicts a bike 1310 with a car 1330 approaching. The safety sensor 1320 of the bike 1310 detects the car 1330 as it approaches and can alert the rider through various types of alerts and signals. In one embodiment, the safety sensor 1320 can detect the car 1330 when it is fifteen feet behind the bike 1310 and five feet away. In such an embodiment, lasers on the safety sensor 1320 can be placed at an angle of 16.20 degrees to detect the car 1330. In some embodiments, the angle of the lasers and the range of detection of the safety sensor 1320 can depend on the desired range and be fabricated to meet such a range.

FIG. 13B depicts an illustration of an embodiment of a laser range of detection 1350. In more detail, FIG. 13B depicts a bike 1360 and a laser 1370. In some embodiments, the average height of a seat on the bike 1360 can be about three feet from the ground. Accordingly, in an embodiment, to have a five foot wide smart lane, the lasers 1370 of the safety sensor can be placed at a 40 degree angle from the y-axis. As illustrated in FIG. 13B, the lasers 1370 can generate a smart lane behind the bike 1360 with a width of five feet when they are placed at a 40 degree angle from the y-axis. In some embodiments, the lasers 1370 can be placed at various angles to produce a smart lane of varying sizes.

In an embodiment, a detection distance may be pre-determined. In one embodiment, the rider may enter the detection distance prior to a cycling session via a user interface. In other embodiments, the detection distance may be entered by an administrator during manufacture. In response, the safety sensor may trigger a change in the light emitted from at least one of the laser lights. For example, in some embodiments, the safety sensors can detect a motor vehicle within a pre-determined distance from the left side of the bike. In some embodiments, the safety sensor can compare current bike characteristics to a detected change in a cycling route condition to identify a dangerous situation. For example, in one embodiment, the safety sensor may compare a current bike speed to a map of the road the rider is cycling on. Based on the comparison, the safety sensor may determine the rider is going too fast for an upcoming turn. In other embodiments, the safety sensor may detect a change in a road condition. The change in the road condition may include at least one of a pothole and a change in elevation of the road, for example a bump in the road.

In some embodiments, the safety sensor system can detect when another rider (i.e., cyclist) is approaching in a blind spot or when a vehicle is coming out of a drive way. In an embodiment, the smart lane can save the cyclist response time when a vehicle is approaching and also alerts vehicles when the cyclist is going to turn. In some embodiments, the system can teach a rider to slow down at intersections and show them if they are a safe rider. In an embodiment, the system can serve as a communication device with cars showing the cyclist's location in the car's GPS system. In some embodiments, the safety sensor can be coupled to many types of vehicles, including at least one of a motorcycle and a motor vehicle. In an embodiment, the safety sensor can collect and analyze data related to many types of vehicles including at least one of a motorcycle and a motor vehicle.

In some embodiments, the method 950 may further include generating, by the safety sensor, an alert to the rider of the bike to notify the rider of the approaching object (980). In an embodiment, the safety sensor can generate a visual alert to the rider using the laser lights to alert the rider of the dangerous situation. In one embodiment, generating the visual alert may include emitting, by the laser lights, a red lane instead of a green lane on the side of the approaching object to alert. In some embodiments, the laser lights may emit flashing lights to alert the rider of the incursion.

In some embodiments, the proximity sensor may generate an audio alert to the rider. In an embodiment, the safety sensors can determine if a vehicle is invading the rider's personal lane (e.g., the smart lane). In some embodiments, when the safety sensors can detect an incursion, the rider's personal lane will start flashing and the speaker from the front console can make a sound alerting the cyclist to move away.

In some embodiments, the safety sensor system may be communicatively coupled to a GPS system. In an embodiment, the GPS system can be a component of the safety sensor. In some embodiments, the safety sensor can detect a change in a cycling route condition by interacting with the GPS system. In an embodiment, the change in the cycling route condition may include upcoming changes in a road or street configuration (e.g., an intersection, sharp turn, rotary, construction, pothole, speed bump, etc.). In an embodiment, the GPS system can be a mapping application, such as Google Maps distributed by Google, Inc, executing on a portable computing device, such as an IPHONE mobile device manufactured by IPHONE, Inc. In some embodiments, the safety sensor may generate at least one of an audio, visual, and a tactile alert to the rider in response to detecting an upcoming intersection.

In one embodiment, the safety sensor may further include a vibration device. In some embodiments, the vibration device may be coupled to the handlebars of the bike. In an embodiment, the safety sensor may transmit a signal to the vibration device to cause the vibration device to vibrate the handlebars and alert the rider of the upcoming intersection. In some embodiments, the safety sensor can compare current bike characteristics to a detected change in a cycling route condition. For example, in one embodiment, a current bike speed can be measured. In response to detecting an upcoming intersection, the safety sensor can vibrate the handle bars to alert the rider to slow down. In an embodiment, a vibrator in communication with the safety sensor can vibrate the handle bars in response to a trigger event from the safety sensor. The trigger event may be in response to a detection of an approaching danger. In some embodiments, the trigger event may be an approaching object, for example a motor vehicle, a motorcycle, or another cyclist. In other embodiments, the trigger event may include a dangerous situation. The dangerous situation may include at least one of an upcoming intersection in the road and a sharp turn in the road.

In some embodiments, the safety sensor may further include a helmet monitoring system. In such an embodiment, safety sensors, similar to those illustrated in FIGS. 8A and 8B can be coupled to the rider's bike helmet. In some embodiments, these helmet sensors can monitor the rider's surroundings and provide feedback to the rider via a small speakers or headphones. In an embodiment, the speakers can alert the rider of events that are happening within a close range such as “car approaching on the left side”. One of the benefits of this concept is that it would encourage cyclist to wear his or her helmet always.

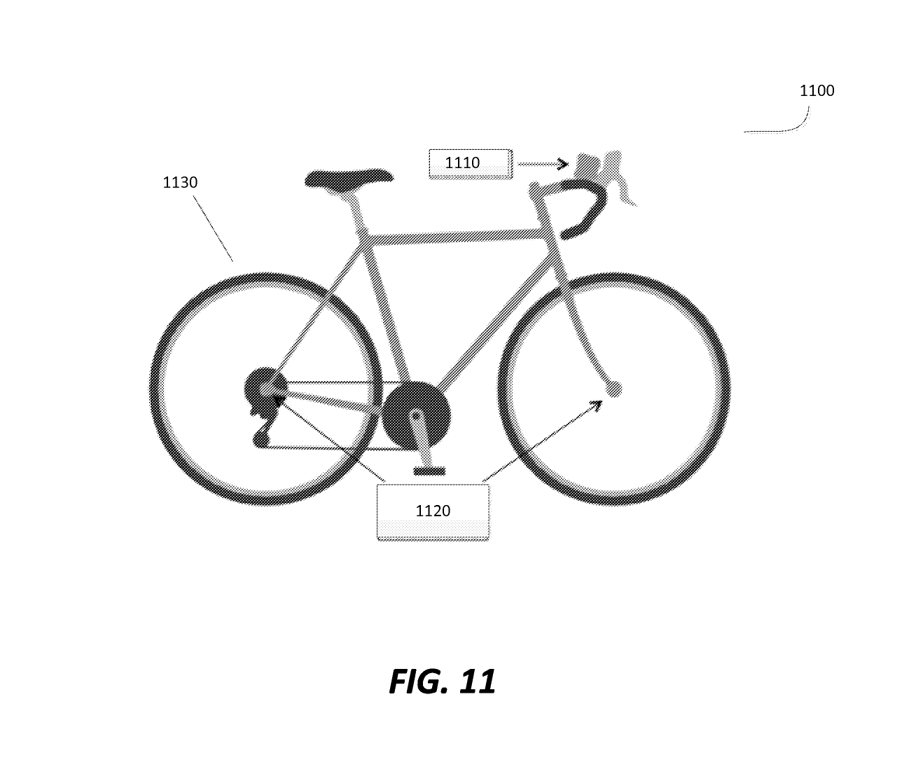

FIG. 11 depicts an illustration of an embodiment of a safety sensor system 1100. In some embodiments, the safety sensor system 1100 can operate similar to the safety sensor 1000, however the placement of the components may be different. In an embodiment, the safety sensor system 1100 can include four proximity sensors 1120 and two speakers 1110. In such an embodiment, the proximity sensors 1120 may be placed on the outside of a chainring or cog set of the bike 1130 to cover both sides of the bicycle. In some embodiments, the four proximity sensors 1120 can be used to determine if any car is approaching the bicycle 1130 and how close it is similar to those described above with respect to FIGS. 8A and 8B. In an embodiment, the proximity sensors 1120 may work with the speakers 1110 to help warn the cyclist by generating an audio alert. In some embodiments, the speakers 1110 can be programmed so that as the car gets closer, the speaker 1110 can start to emit sound with shorter intervals. In an embodiment, the safety sensor 1100 can warn the rider if they are in possible danger and/or if the car may invade their personal space (e.g., within the smart lanes boundaries). Further, the safety sensor 1100 can warn people around them (e.g., other cyclists, runners, walkers) to alert them to move further away from the car.

In some embodiments, a safety sensor can include a “safety officer application” to collect the information from the crash detection module and provide advice/recommendations to the rider indicating a risk factor related to the rider's performance. In an embodiment, the safety office application may be executing on a hand held computing device or a wearable computing device. In some embodiments, the safety officer application can transmit and receive information and data from the safety sensor.

In some embodiments, the safety sensor can include a real-time feedback via left\right horns (or haptic/visual feedback by smartphone), to show the direction of the approaching dangerous object. For example, in the case of a “dangerous” approaching object to the bicycle, the horns can alarm and warn the rider to react. In some embodiments, the dangerous approaching object can be defined as a quick movement of two objects to each other that can potentially result in a crash. In an embodiment, the left/right horns can respond depending the position of the dangerous object, such as a vehicle. In some embodiments, based on the horn sound, the rider can have a few milliseconds to react and at least reduce the crash intensity. In an embodiment, the horn can be loud enough to be heard by the driver of the other vehicle as well.

In another embodiment, the safety sensor can include an off-line feedback via smartphone application (i.e. “safety office”), to educate individuals on their cycling behavior (i.e. how risky they drive and what the chance of accident was in the past 30 days).

This system can also be realized as a bi-directional transceiver module between the cyclist and the other drivers. So when they approach dangerously to each other, in addition to the cyclist the car driver also receives the warning feedbacks via the appropriate medium implemented in his personal car.

Implementations of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, i.e., one or more circuits of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices).

The term “data processing apparatus” or “computing device” encompasses various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a circuit, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more circuits, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular implementations of particular inventions. Certain features described in this specification in the context of separate embodiments can also be implemented in combination in a single embodiment. Conversely, various features described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated in a single software product or packaged into multiple software products.

References to “or” may be construed as inclusive so that any terms described using “or” may indicate any of a single, more than one, and all of the described terms.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A method comprising:
creating, by a safety sensor, a virtual smart lane around a bike operated by a rider during a cycling session, the smart lane indicates a safe zone around the bike;
detecting, by the safety sensor, an object approaching the virtual smart lane during the cycling session; and
generating, by the safety sensor, an alert to the rider of the bike to notify the rider of the approaching object.

2. The method of claim 1, further comprising generating, by the safety sensor, the virtual smart lane on a surface around the bike during the cycling session.

3. The method of claim 1, further comprising displaying, by the safety sensor, the virtual smart lane on a computing device display visible by the rider during the cycling session.

4. The method of claim 1, wherein detecting further comprises determining, by the safety sensor, the object has come within a pre-determined distance of the bike.

5. The method of claim 1, further comprising detecting, by the safety sensor, a change in a cycling route condition.

6. The method of claim 1, further comprising detecting, by the safety sensor, a change in a road condition, the change in the road condition comprising at least one of a pothole and a change in elevation of the road.

7. The method of claim 1, wherein generating the alert further comprises transmitting, by the safety sensor, to a processor commands to activate at least one of a speaker, a laser light, and a vibrator.

8. The method of claim 7, wherein the alert comprises at least one of an audio alert, visual alert, and a tactile alert.

9. The method of claim 8, wherein the audio alert comprises generating, by the speaker, audio commands to the rider to change a current cycling characteristic of the cycling session.

10. The method of claim 8, wherein the visual alert comprises changing, by the laser light, a light behavior corresponding the smart lane to change a visual view of the smart lane.

11. The method of claim 10, wherein changing the light behavior comprises blinking, by the laser light, lanes of the virtual smart lane to notify at least one of the rider and an operator of a motor vehicle, when the motor vehicle approaches the virtual smart lane.

12. The method of claim 8, wherein the tactile alert comprises vibrating, by the vibrator, a component of the bike structure to alert the rider of the approaching object.

13. The method of claim 8, wherein the tactile alert further comprises vibrating, by the vibrator, a component of the bike structure to alert the rider of a dangerous situation, the dangerous situation comprises at least one of an upcoming intersection in the road and a sharp turn in the road.

14. The method of claim 1, wherein the safety sensor is coupled to at least one of a motorcycle and a motor vehicle.

15. The method of claim 1, further comprising receiving, by the safety sensor, input from a user via a user interface.

16. A system comprising:
a safety sensor configured to:
create a virtual smart lane around a bike operated by a rider during a cycling session, the virtual smart lane indicates a safe zone around the bike;
detect an object approaching the virtual smart lane during the cycling session; and
generate an alert to the rider of the bike to notify the rider of the approaching object.

17. The system of claim 16, wherein the safety sensor is configured to generate the virtual smart lane on a surface around the bike during the cycling session.

18. The system of claim 16, wherein the safety sensor is configured to display the virtual smart lane on a computing device display visible by the rider during the cycling session.

19. The system of claim 16, wherein the safety sensor is configured to determine the object has come within a pre-determined distance of the bike.

20. The system of claim 16, wherein the safety sensor is configured to detect a change in a cycling route condition.

21. The system of claim 16, wherein the safety sensor is configured to detect a change in a road condition, the change in the road condition comprising at least one of a pothole and a change in elevation of the road.

22. The system of claim 16, wherein safety sensor is configured to transmit to a processor commands to activate at least one of a speaker, a laser light, and a vibrator.

23. The system of claim 22, wherein the alert comprises at least one of an audio alert, visual alert, and a tactile alert.

24. The system of claim 23, wherein the speaker is configured to generate an audio command to the rider to change a current bike characteristic of the cycling session.

25. The system of claim 23, wherein the laser light is configured to change a light behavior of the virtual smart lane to change a visual view of the virtual smart lane.

26. The system of claim 23, wherein the laser light is configured to blink lanes of the virtual smart lane to notify the rider when a motor vehicle approaches the virtual smart lane.

27. The system of claim 23, wherein the laser light is configured to change a display of the virtual smart lane on a hand held computing device to notify the rider when a motor vehicle approaches the virtual smart lane.

28. The system of claim 23, wherein the vibrator is configured to vibrate a component of the bike structure to alert the rider of the approaching object.

29. The system of claim 23, wherein the vibrator is configured to vibrate a component of the bike structure to alert the rider of a dangerous situation, the dangerous situation comprises at least one of an upcoming intersection in the road and a sharp turn in the road.

30. The system of claim 16, wherein the safety sensor is coupled to at least one of a motorcycle and a motor vehicle.

31. The system of claim 16, wherein the safety sensor is configured to receive input from a user via a user interface.
